(19) United States
(12) Patent Application Publication
(10) Pub. No.: US 2013/0222172 A1
(43) Pub. Date: Aug. 29, 2013

(54) DETERMINING PENETRABILITY OF A BARRIER

(71) Applicant: L-3 COMMUNICATIONS CYTERRA CORPORATION, (US)

(72) Inventors: Christopher Gary Sentelle, Orlando, FL (US); Donald Charles Wright, Orlando, FL (US)

(73) Assignee: L-3 COMMUNICATIONS CYTERRA CORPORATION, ORLANDO, FL (US)

(21) Appl. No.: 13/779,143

(22) Filed: Feb. 27, 2013

Related U.S. Application Data
(60) Provisional application No. 61/604,085, filed on Feb. 28, 2012.

(51) Int. Cl. G01S 13/88

(52) U.S. Cl. CPC G01S 13/88
USPC 342/22

(57) ABSTRACT

A through-wall radar system includes a transceiver configured to receive and transmit multiple radar signals, each radar signal associated with a frequency that nominally passes through a barrier. The system includes a processor coupled to an electronic storage, the processor configured to sense a portion of a signal transmitted by the transceiver and analyze the sensed portion of the signal to determine a penetrability of a barrier. The system also includes an output configured to present a perceivable indicator related to the determined penetrability of the barrier.

### CROSS-REFERENCE TO RELATED APPLICATIONS

This application claims the benefit of U.S. Provisional Patent Application No. 61/604,085, filed Feb. 28, 2012, the entirety of which is hereby incorporated by reference as if fully set forth therein.

### TECHNICAL FIELD

This disclosure relates to determining penetrability of a barrier.

### SUMMARY

In one general aspect, a system includes a transceiver configured to receive and transmit multiple radar signals, each radar signal associated with a frequency that nominally penetrates a barrier. The system also includes a processor coupled to an electronic storage, the electronic storage storing instructions that, when executed, cause the processor to perform operations including sensing a portion of a signal transmitted by the transceiver, and analyzing the sensed portion of the signal to determine a penetrability of a barrier. The system further includes an output configured to present a perceivable indicator related to the determined penetrability of the barrier.

Implementations may include one or more of the following features. The portion of the signal may comprise a leakage signal. The portion of the signal may comprise a reflection of the signal from the barrier. The barrier may include a wall of a structure. The penetrability of the barrier may include an estimate of one or more of a dielectric constant or a loss of the barrier. The output may present a visual indicator related to the determined penetrability.

In another general aspect, a method includes accessing first data including a sensed portion of a signal received by a radar transceiver operating in free space, accessing second data including a sensed portion of a signal received by the radar transceiver operating close to a barrier, determining a first leakage signal from the first data, determining a second leakage signal from the second data, comparing the first leakage signal and the second leakage signal, determining a penetrability of the barrier based on the comparison, and presenting the penetrability of the barrier.

Implementations may include one or more of the following features. Determining the first leakage signal may include determining a maximum amplitude of the first data and determining the second leakage signal may include determining a maximum amplitude of the first data. The maximum amplitude of the first data may be a local maximum of a portion of the first data and the maximum amplitude of the second data may be a local maximum of a portion of the second data. The first leakage signal may have a first amplitude value, the second leakage signal may have a second amplitude value, and comparing the first leakage signal and the second leakage signal may include determining a difference between the first amplitude value and the second amplitude value.

In some implementations, the first amplitude value may occur at a first time and the second amplitude value may occur at a second time, and comparing the first leakage signal and the second leakage signal may further include determining a difference between the first time and the second time. The first leakage signal may have a first amplitude value and may occur at a first time, the second leakage signal may have a second amplitude value and may occur at a second time, and comparing the first leakage signal and the second leakage signal may include determining a difference between the first time and the second time. Determining the penetrability of the barrier based on the comparison may include comparing the difference between the first amplitude value and the second amplitude value to a threshold. The penetrability of the barrier may include an amount of loss caused by the barrier. The penetrability of the barrier may be an indication of usability of the radar transceiver, and presenting the penetrability of the barrier may provide an indicator to the user of whether the transceiver is usable. Accessing second data may include accessing reflections received by the radar when the transceiver is coupled to the barrier.

In another general aspect, a method includes accessing first data including a sensed portion of a signal received by a radar transceiver operating in free space, accessing second data including a sensed portion of a signal received by the radar transceiver operating close to a barrier, determining a first leakage signal from the first data, determining a second leakage signal from the second data, comparing the first leakage signal and the second leakage signal, determining whether signals transmitted from the transceiver pass through the barrier based on the comparison, if the signals are determined to not pass through the barrier, presenting a first perceivable indicator, and if the signals are determined to pass through the barrier, presenting a second perceivable indicator that is distinguishable from the first perceivable indicator.

Implementations may include one or more of the following features. The first and second perceivable indicators may be visual indicators, each having a distinct display style. The first and second perceivable indicators may be audible indicators, each having a distinct sound.

Implementations of the techniques discussed above may include a method or process, a system or apparatus, a kit, method, and/or process for retrofitting an existing system, and/or computer software stored on a computer-readable storage medium.

### BRIEF DESCRIPTION OF THE DRAWINGS

FIG. 1A shows an example of a radar system operating in free space.

FIG. 1B shows an example of the radar system of FIG. 1A coupled to a barrier.

FIG. 2A is an illustration of example data from the radar system of FIG. 1A.

FIG. 2B is an illustration of example data from the radar system of FIG. 1B.

FIG. 3 shows another example of a radar system coupled to a barrier.

FIG. 4 illustrates example of data from the radar system of FIG. 3.

FIGS. 5, 6, 7A, and 7B are additional illustrations of example of data from a radar system.

FIG. 8 is a block diagram of a radar system.

FIGS. 9A and 9B are examples of a display on a radar system.

### DETAILED DESCRIPTION

The techniques discussed below may be employed to determine how well, if at all, a transmitted radar signal penetrates a barrier. The determination may use the leakage signal to estimate the penetrability of the barrier and to assist in determining when other sensors should be used in conjunction with the radar.

Through-wall radar systems may be used to image and/or detect objects that are on an opposite side of a barrier as compared to the location of the through-wall radar. For example, a through-wall radar system may be used to determine, from the outside of a building and without entering the building, whether moving or still objects are inside of the building. To image and/or detect objects inside of the building, the radar system transmits signals that pass through the wall of the building and into a space enclosed by the wall. The transmitted signals reflect off of objects in the space and pass back through the wall and are detected by the radar system.

However, under certain conditions, such as a wall that has a relatively high moisture content and/or metal content, the wall may be impenetrable, or nearly impenetrable, to electromagnetic signals of a particular frequency. Further, the ability of electromagnetic signals to penetrate a particular barrier may change over time. For example, a relatively new adobe wall may have a higher water content than a more mature adobe wall. For electromagnetic signals having frequencies that are absorbed by water (or are attenuated by water), the relatively new adobe wall is a higher loss medium than the mature adobe wall even though both walls are made of similar, or the same, materials. As a result, a radar transmitter that produces signals in a frequency band that is absorbed by water may have a reduced, or non-existent, ability to penetrate the fresh adobe wall. While adobe has been described for example purposes, walls made from other materials may have similar changes in penetrability over time, and implementations of the present disclosure are not limited to any particular wall material. In situations where a wall may be impenetrable, or nearly impenetrable, to electromagnetic signals of a particular frequency, the radar system has a diminished ability to detect or sense signals that are returned from the space inside of the room because few or no signals, or few signals, are able to penetrate the wall to reach the space. Thus, the radar system and/or an operator of the system may erroneously determine that there are no objects in the space.

The techniques discussed below may improve performance in such situations by determining whether or not the radar signals are able to penetrate through the barrier, e.g., determining the penetrability of the barrier. As a result, the techniques discussed below may be used with a radar system to improve its performance and usability as well as reducing the incidence of false negatives. Further, the techniques discussed below use the leakage signal of the radar system. The leakage signal may be considered as the portion of the transmitted signal that is directly observed in the received signal, and the leakage signal is measured each time a received signal is measured by the transceiver. As some reflections of a transmitted signal from a barrier may be practically indistinguishable from the leakage signal, the leakage signal may also include some reflections of the transmitted signal from the barrier. Many systems attempt to eliminate the leakage signal, and, thus, the techniques discussed below offer advantages by using data that is already present in the data received by the radar system and also offer a technique to use data that may otherwise be considered as noise or extraneous data.

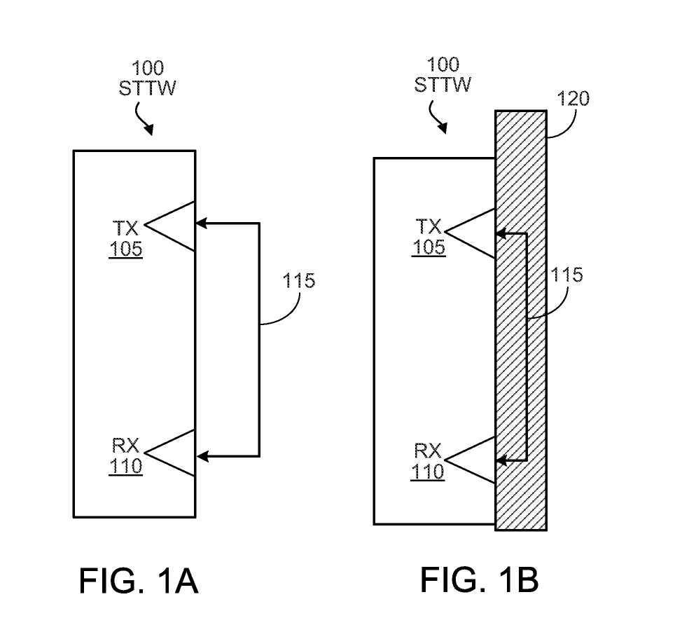

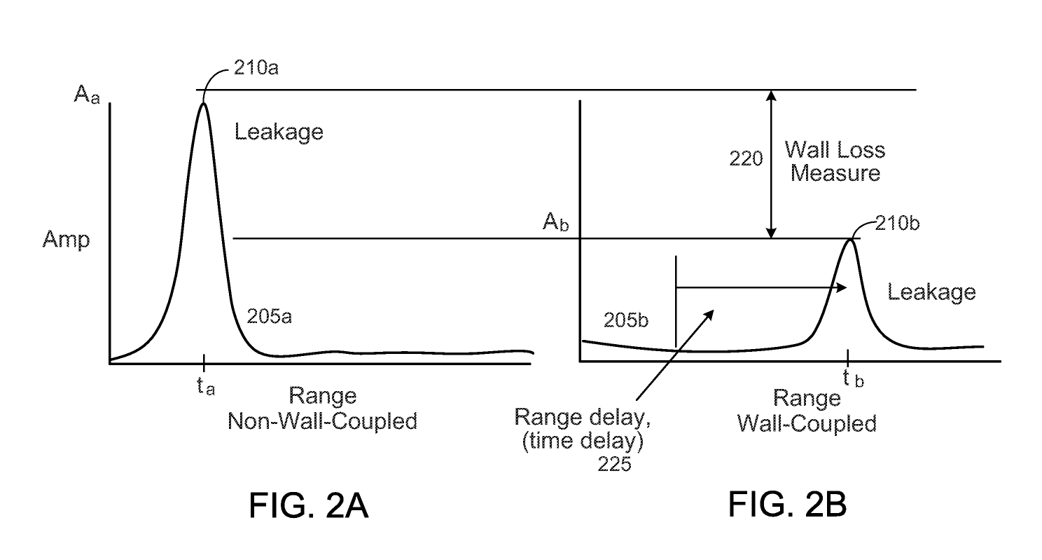

FIG. 1A shows an example of a radar system operating in free space. The radar system 100 includes a transmit antenna 105 and a receive antenna 110. The radar system 100 may be referred to as a sense through the wall (STTW) system, and the radar system 100 may be a stepped-frequency continuous wave radar (SFCW). In operation, the system 100 generates multiple electromagnetic signals, each at a different frequency, from the transmit antenna 105. The transmit antenna 105 directs the multiple signals towards a barrier 120 to detect objects that are on the other side of the barrier 120. The receive antenna 110 detects reflections of the transmitted signals. In addition to reflections of the transmitted signals, the receive antenna also observes, senses, or detects a portion of the signals transmitted from the antenna 105. The portion of the transmitted signal that is observed by the receive antenna 110 may be referred to as a leakage signal 115.

FIG. 1B shows the system 100 is coupled to a barrier 120. The barrier 120 may be, for example, a wall of a building. When placed against the barrier 120, the path of the leakage signal is changed, and the leakage signal 115 passes through the barrier 120 before being sensed by the receive antenna 110. Materials that are denser than air typically have a higher relative dielectric constant and are more lossy than air. The increased dielectric constant results in an electromagnetic wave propagating through the material at a lower velocity than it would through air, and the increased RF loss of the material causes a relatively greater portion of the electromagnetic signal to be attenuated and/or absorbed. Because the loss and the relative dielectric constant of the material of the barrier 120 are higher than that of free space, the leakage signal 115 becomes attenuated and delayed from passing through the material of the barrier 120. Properties of the barrier 120, such as relative dielectric constant and the loss of the material, may be estimated by comparing the amplitude and time of occurrence of the leakage signal 115 in the case where the radar 100 is operating in free space (FIG. 1A) to the leakage signal 115 where the radar is coupled to the barrier 120 (FIG. 1B).

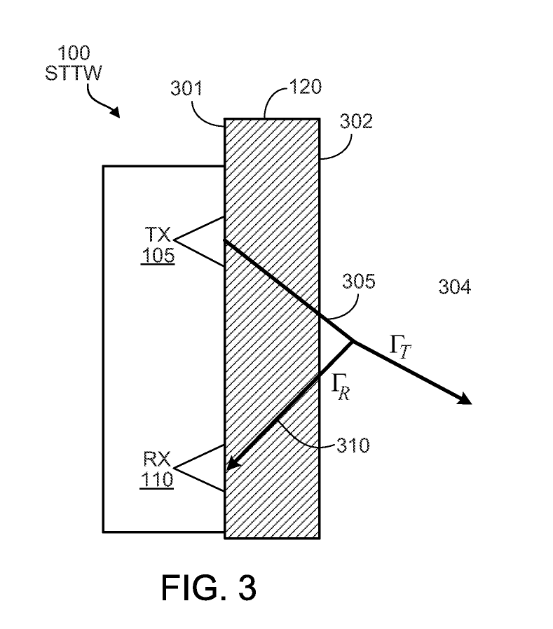

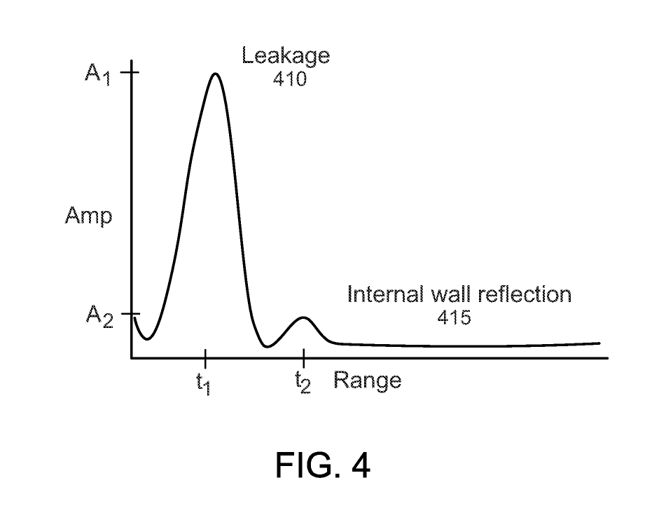

FIG. 2A shows an example of data obtained from the radar system 100 when the system 100 is operated in free space (FIG. 1A). FIG. 2B shows an example of data obtained from the radar system when the system 100 is coupled to the barrier 120 (FIG. 1B). The data as presented in FIG. 2A and FIG. 2B may be referred to as a range profile that shows amplitude of a radar return as a function of range (time). The range profile may be generated by transforming a radar return received in the frequency domain by the system 100 into time-domain data with an inverse Fourier transform. The range profile includes data that represents the leakage signal and data that represents reflections from objects in the vicinity of the radar 100.

Referring to FIG. 2A, a range profile 205a is shown. Because the range profile 205a includes data that represents the leakage signal and data reflected from objects, an amplitude value and time of occurrence of a leakage signal 210a may be determined from the range profile 205a. In the example shown, the leakage signal 210a is associated with an amplitude Aₐ and a time tₐ.

In some implementations, the amplitude of the leakage signal 210a is associated with the maximum amplitude in a portion of the range profile. For example, the leakage signal may manifest itself in a particular range of times (or bins that correspond to time ranges) of the range profile or at a particular bin. The leakage signal may be present at a bin that corresponds to zero range, or in a range of bins that represent a small portion of the total bins in the range profile, such as the first ten bins in a 1024-bin range profile. The maximum amplitude value in a particular range of bins is determined, and the value of the amplitude of that bin and the time of the occurrence of that bin are associated with the leakage signal 210a. In other implementations, the amplitudes and times of neighboring bins may be interpolated to determine the value and time associated with the leakage signal.

FIG. 2B shows a range profile 205b that includes a leakage signal 210b. As compared to the leakage signal 210a (FIG. 2A), the leakage signal 210b (FIG. 2B) is delayed in time and reduced in amplitude because the return signal used to generate the range profile 205b was collected with the radar 100 coupled to the barrier 120. The range profile 205b is analyzed to locate the leakage signal 205b. The leakage signal 210b may be located as discussed with respect to FIG. 2A.

In the example shown, the leakage signal 210b has an amplitude of A_{b} and occurs at a time t_{b}. The loss from the barrier 120, or the amount of attenuation of the barrier 120, may be determined from, or estimated based on, the difference 220 between the amplitude Aₐ and the amplitude A_{b}. Further, the relative dielectric constant of the barrier 120 may be estimated from the amount of the delay the barrier 120 causes to a radar signal that propagates through the barrier 120. Thus, the difference 225 between the time (tₐ) and the time (t_{b}) may be used to estimate the relative dielectric constant of the material(s) in the barrier 120. The estimation of the loss and the relative dielectric provide an indication of whether a radar signal generated by the system 100 is able to penetrate the barrier 120.

For example, the indication of whether a radar signal generated by the system 100 is able to penetrate the barrier 120 may be determined based on the difference 220 between the amplitude Aₐ and the amplitude A_{b}. The difference 220 may be compared to one or more thresholds that correspond to different levels of penetrability. For example, a threshold of 80% may be used to determine that a difference 220 that corresponds to an 80% loss in amplitude may correspond to poor or low penetrability and a threshold of 5 dB may be used to determine that a difference 220 corresponding to less than 5 dB may correspond to good or high penetrability.

In some implementations, the range profile 205a and/or Amplitude Aₐ may be stored in memory for future use. For example, the system 100 may initially measure a leakage signal when the radar system 100 is not coupled to a barrier 120, and store that measurement in a memory of the system 100. When determining the penetrability of a barrier 120 at any later point in time, the system 100 may measure a leakage signal when the radar system 100 is coupled to the barrier 120, and compare the new measurements to the previously stored measurement. In some implementations, the system 100 may periodically take a second measurement when the system 100 is not coupled to a barrier 120 for recalibration.

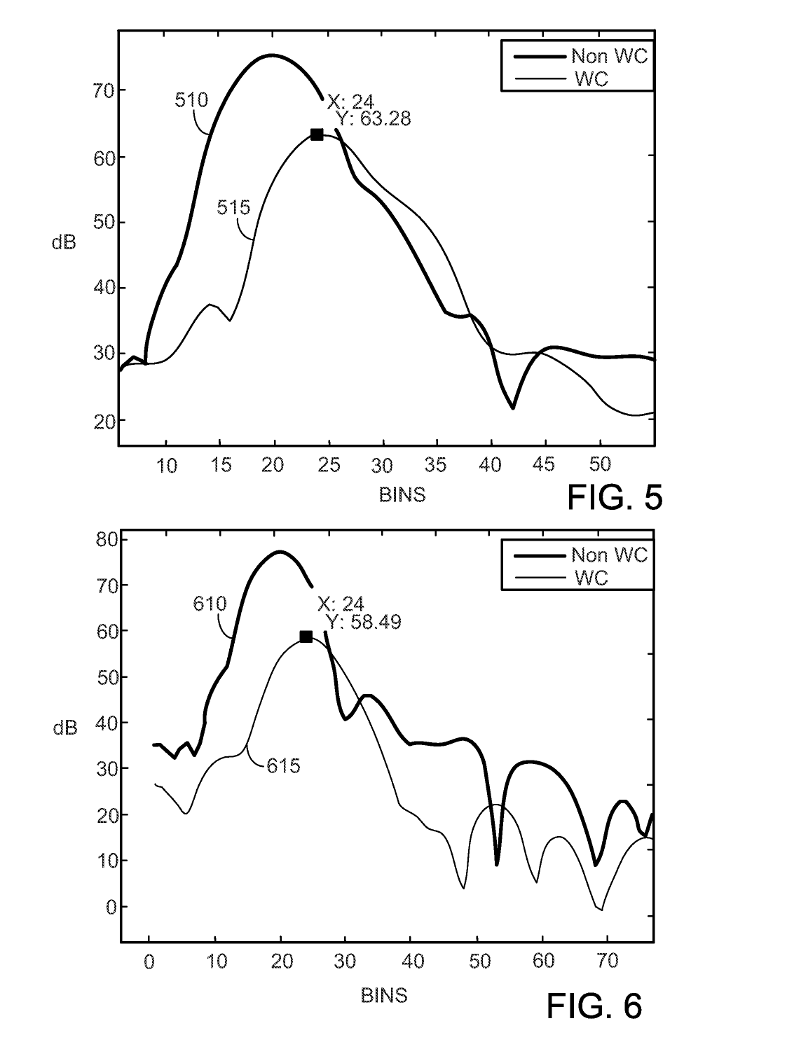

In addition to, or instead of, the leakage signal, internal reflections, such as a reflection between a back side of a barrier and a medium beyond the back side, may be used to characterize the barrier. FIG. 3 shows another example of coupling the system 100 to the barrier 120. In this example, the system 100 is placed on a side 301 of the barrier 120. The transmit antenna 105 transmits a signal 305 through the side 301 and into the barrier 120. A portion of the signal 305 passes through a back side 302 of the barrier 120 and into a space 304, and a portion of the signal 305 is reflected from the back side 302 as reflected signal 310 and reaches the receive antenna 110. Thus, in addition to detecting the leakage signal, the receive antenna 110 also may detect internal reflections of the signals transmitted by the transmit antenna 105.

The space 304 may be air, such as when the side 302 of the barrier 120 is adjacent to a room within the building. In some examples, the space 304 may be another part of the barrier 120, or another barrier, that is a non-air material with a dielectric constant that is different from that of the other parts of the barrier 120.

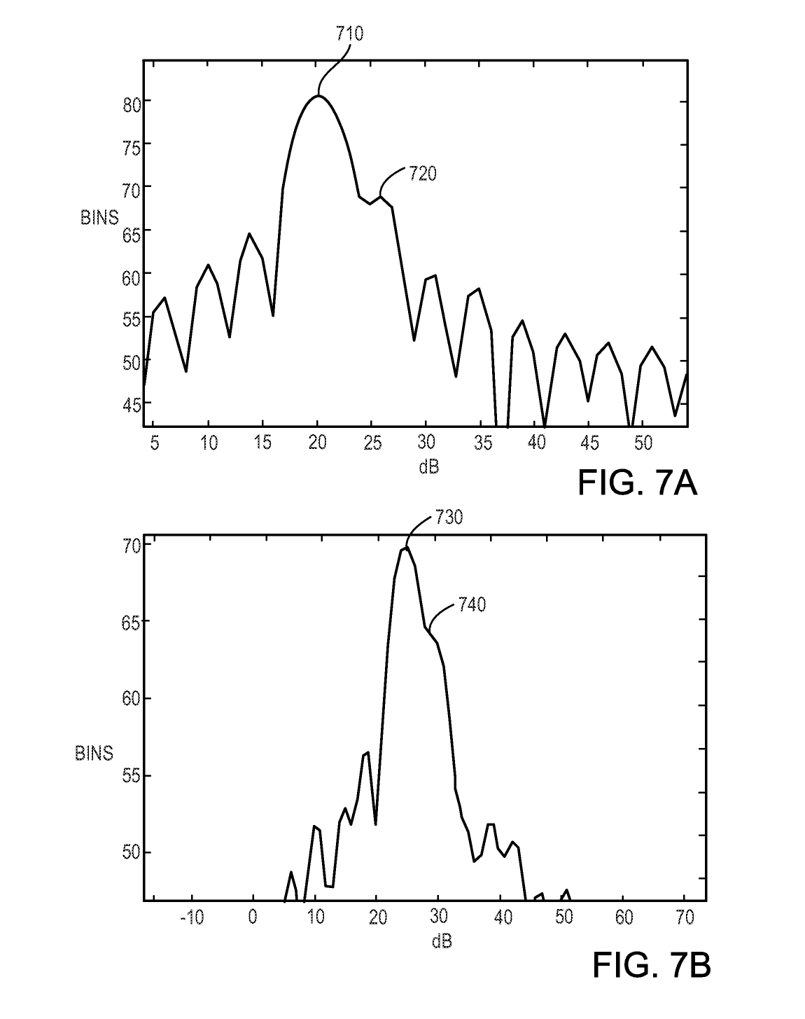

FIG. 4 shows an example of data obtained by the radar 100 in the scenario shown in FIG. 3. In the example of FIG. 4, a range profile 405 includes a representation of a leakage signal 410 and an internal wall reflection 415. The leakage signal 410 is associated with an amplitude A₁ and occurs at a time t₁, and the internal wall reflection 415 is associated with an amplitude A₂ and occurs at a time t₂. The amplitude and time of the internal wall reflection 415 also may be used to estimate the relative dielectric constant and attenuation of the barrier 120. In some implementations, the amplitude and time of the internal wall reflection 415 may be used in conjunction with the measured, or otherwise known or estimated, thickness of the barrier 120 to determine the dielectric of the barrier 120.

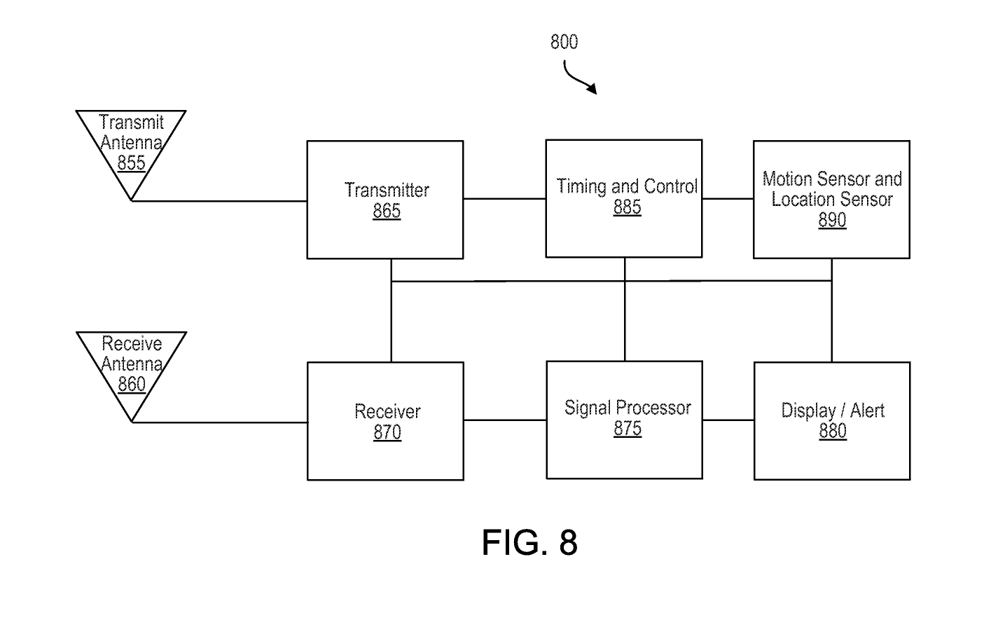

FIG. 5 shows another example of range profiles generated from radar data. A range profile 510 generated by operating a radar without coupling the radar to a barrier, and a range profile 515 is generated by coupling the radar to a barrier (such as a wall). As shown, the range profile 515 is reduced in attenuation and delayed as a result of being generated from data obtained while the radar is coupled to the barrier. The difference between the amplitude of the leakage signal determined from the range profile 510 and the range profile 515 is about 12 dB, and the delay is about 0.29 meters (about 1.95 ns).

FIG. 6 shows another example of range profiles generated from radar data. A range profile 610 generated by operating a radar without coupling the radar to a barrier, and a range profile 615 is generated by coupling the radar to a barrier (such as a wall). In this example, the barrier is a high-loss barrier. As shown, the range profile 615 is generally reduced in attenuation and delayed as a result of being generated from data obtained while the radar is coupled to the barrier. The difference between the amplitude of the leakage signal determined from the range profile 610 and the range profile 615 is about 19 dB.

FIGS. 7A and 7B show example range profiles that include internal reflections. FIG. 7A shows a range profile obtained from operating a radar in free space (or at a stand-off), and FIG. 7B shows a range profile obtained from coupling the radar to a barrier. In the example shown in FIG. 7A, the reference 710 represents the return off of the front of the wall of a barrier (such as barrier 120) and the reference 720 represents an internal reflection. The leakage signal (not shown), is within the first few bins of the range profile, for example, before the fifth range bin (shown as number 5 on the x-axis of FIG. 7A). When the radar is operated at a stand-off distance from the wall, the radar is not coupled to the barrier. In such an arrangement, in addition to looking at the leakage signal, representations of internal reflections (such as the internal reflection 720) may also be used to determine wall penetrability. In FIG. 7B, the leakage signal is shown at 730 and the internal reflection is shown at 740.

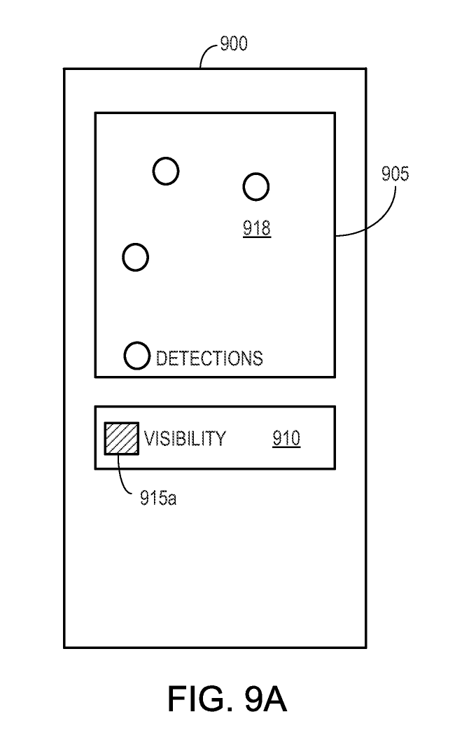

FIG. 8 shows a block diagram of a device 800 that may be used as a radar system or a radar device. The device 800 may be used in any of the examples discussed above. The device 800, which may be a handheld stepped-frequency radar scanner, includes antennas 855 and 860 for transmitting and receiving a stepped-frequency radio frequency signal (an “RF signal”). Although in this example, the device 800 is hand-held, in other examples, the device 800 may be wall-mounted, vehicle-mounted, or mounted on a push-cart.

The device 800 is shown as a bistatic radar system, in that there are separate antennas for transmitting and receiving the RF signal. In particular, the antenna 855 is connected to a radar transmitter and transmits an RF signal toward a target, and the antenna 860 is connected to a radar receiver and receives a portion of the RF signal that is reflected by the target. In another implementation, device 800 may be a monostatic radar system that uses a single antenna to transmit and receive the RF signal. The following discussion assumes that the antenna 855 is the transmitting antenna and the antenna 860 is the receiving antenna.

The transmit antenna 855 is connected to a radar transmitter 865 that transmits an RF signal toward a target. The RF signal includes frequencies that cover a bandwidth in increments of frequency steps. For example, the signal may include a nominal frequency operating with a center frequency in the UHF, L, S or X bands. In another example, the signal may include a range of frequencies between about 2900 MHz and 3600 MHz.

The receive antenna 860 is connected to a radar receiver 870 and receives the reflected RF signal from the target. For simplicity, the receive antenna 860 is discussed in terms of the implementation including a single antenna. Nevertheless, the receive antenna 860 may represent two or more antennas.

Implementations employing multiple antennas may each have a dedicated receiver or may share the receiver 870. The receiver 870 is coupled to a signal processing system 875 that processes received RF signals from the receiving antenna 860. The signal processing system 875 may be any type of electronic processor, and the signal processing system may include an electronic storage (not shown) that stores instructions that, when executed cause the electronic processor to process, manipulate, or analyze data from the receiver 870. For example, the signal processing system 875 may be used to determine an amplitude and delay associated with a leakage signal and estimate a relative dielectric constant and/or loss of a barrier based on the amplitude and delay.

The signal processing system 875 is coupled to a display 880 and a timing and control module 885. The display 880 provides an audible and/or a visual alert when an object is detected by the scanner. The timing and control module 885 may be connected to the transmitter 865, the receiver 870, the signal processor 875, and the display 880. The timing and control module provides signals, such as a clock signal and control signals, to the other components of the device 850.

The signal processing system 875 can include an interferometer/interferometer processing. The interferometer can process received signal to enable location of entities or targets within a given environment. The interferometer also can provide simultaneous stationary object mapping capability. In particular, the interferometer may receive channel signals, use a low-pass filtered to provide stationary object mapping, and use a high-pass filter for moving target angle estimation.

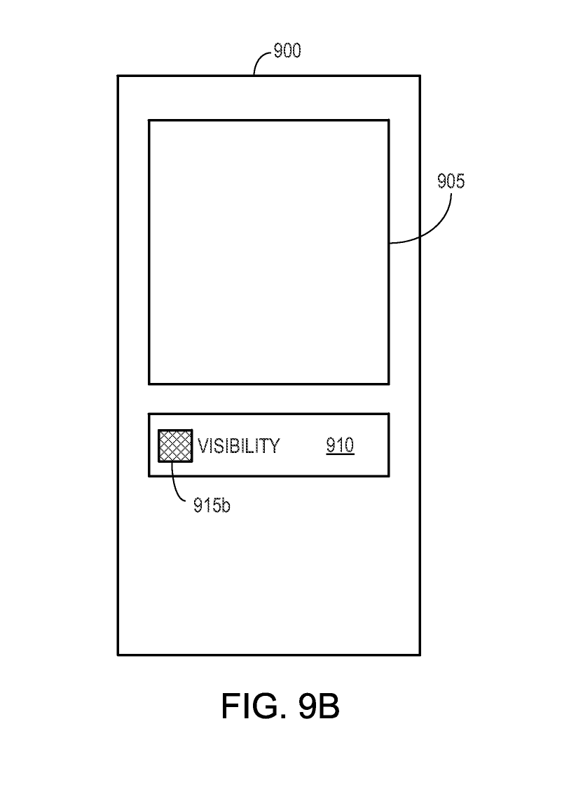

FIGS. 9A and 9B show examples of a display on a radar system. FIGS. 9A and 9B show examples of a radar device 900 that includes a display 905 and a visibility indicator 910. The radar device 900 may be similar to the system 100, the device 800, or any other radar that produces signals that are used to detect or image objects on another side of a barrier.

In the example shown in FIG. 9A, the display 905 shows representations 918 of objects that are on an opposite side of a barrier as compared to the radar 900. The visibility indicator 910 is shown with a display style 915a that indicates that the signals transmitted by the radar 900 are penetrating the barrier. Thus, the visibility indicator 910 provides an indication to the operator of the radar 900 that the radar is operating as expected. The radar 900 presents the indicator 910 in the display style 915a based on a determination of the properties (such as relative dielectric constant and loss) of the barrier.

In the example shown in FIG. 9B, the display 905 does not show any representations of objects, and the visibility indicator 910 has a display style 915b that indicates poor visibility due to the transmitted signals having little or no penetration through the barrier. As such, although the display 905 does not show detections of objects, there may be objects beyond the barrier. In this instance, the visibility indicator 910 may prompt the operator to use an alternate procedure to examine the barrier.

Although the example shown in FIG. 9A and 9B use a visual indicator, in other examples, other perceivable indicators may be used. For example, an audible sound may be used to inform the operator of the condition of the barrier. Additionally, the indicator 910 may be used to show a range of conditions of the barrier and the ability of transmitted signals to penetrate the barrier. For example, the indicator 910 may show “good,” “average,” or “poor” in words and/or visual display style to inform the operator of the radar 900 of the operating conditions.

A number of implementations have been described. Nevertheless, it will be understood that various modifications may be made without departing from the scope of the disclosure. For example, instead of coupling the radar to the barrier to determine loss and relative dielectric constant, the radar may be close to the barrier but not touching. Additionally, loss and relative dielectric constant may be determined with the radar at a stand-off distance and not touching the barrier.

What is claimed is:

1. A system comprising:
a transceiver configured to receive and transmit multiple radar signals, each radar signal associated with a frequency that nominally penetrates a barrier;
a processor coupled to an electronic storage, the electronic storage storing instructions that, when executed, cause the processor to perform operations comprising:
sensing a portion of a signal transmitted by the transceiver; and
analyzing the sensed portion of the signal to determine a penetrability of a barrier; and
an output configured to present a perceivable indicator related to the determined penetrability of the barrier.

2. The system of claim 1, wherein the portion of the signal comprises a leakage signal.

3. The system of claim 1, wherein the portion of the signal comprises a reflection of the signal from the barrier.

4. The system of claim 1, wherein the barrier comprises a wall of a structure.

5. The system of claim 1, wherein the penetrability of the barrier comprises an estimate of one or more of a dielectric constant or a loss of the barrier.

6. The system of claim 1, wherein the output presents a visual indicator related to the determined penetrability of the barrier.

7. A method comprising:
accessing first data comprising a sensed portion of a signal received by a radar transceiver operating in free space;
accessing second data comprising a sensed portion of a signal received by the radar transceiver operating close to a barrier;
determining a first leakage signal from the first data;
determining a second leakage signal from the second data;
comparing the first leakage signal and the second leakage signal;
determining a penetrability of the barrier based on the comparison; and
presenting the penetrability of the barrier.

8. The method of claim 7, wherein determining the first leakage signal comprises determining a maximum amplitude of the first data, and determining the second leakage signal comprises determining a maximum amplitude of the first data.

9. The method of claim 8, wherein the maximum amplitude of the first data is a local maximum of a portion of the first data, and the maximum amplitude of the second data is a local maximum of a portion of the second data.

10. The method of claim 7, wherein:
the first leakage signal has a first amplitude value,
the second leakage signal has a second amplitude value, and
comparing the first leakage signal and the second leakage signal comprises determining a difference between the first amplitude value and the second amplitude value.

11. The method of claim 10, wherein the first amplitude value occurs at a first time and the second amplitude value occurs at a second time,
wherein, comparing the first leakage signal and the second leakage signal further comprises determining a difference between the first time and the second time.

12. The method of claim 7, wherein:
the first leakage signal has a first amplitude value and occurs at a first time,
the second leakage signal has a second amplitude value and occurs at a second time, and
comparing the first leakage signal and the second leakage signal comprises determining a difference between the first time and the second time.

13. The method of claim 7, wherein determining the penetrability of the barrier based on the comparison comprises comparing the difference between the first amplitude value and the second amplitude value to a threshold.

14. The method of claim 7, wherein the penetrability of the barrier is based on an amount of loss caused by the barrier.

15. The method of claim 7, wherein the penetrability of the barrier is an indication of usability of the radar transceiver, and presenting the penetrability of the barrier provides an indicator to the user of whether the transceiver is usable.

16. The method of claim 7, wherein accessing second data comprises accessing a signal received by the transceiver when the transceiver is coupled to the barrier.

17. A method comprising:
accessing first data comprising a sensed portion of a signal received by a radar transceiver operating in free space;
accessing second data comprising a sensed portion of a signal received by the radar transceiver operating close to a barrier;
determining a first leakage signal from the first data;
determining a second leakage signal from the second data;
comparing the first leakage signal and the second leakage signal;
determining whether signals transmitted from the transceiver pass through the barrier based on the comparison;
if the signals are determined to not pass through the barrier, presenting a first perceivable indicator; and
if the signals are determined to pass through the barrier, presenting a second perceivable indicator that is distinguishable from the first perceivable indicator.

18. The method of claim 17, wherein the first and second perceivable indicators are visual indicators, each having a distinct display style.

19. The method of claim 17, wherein the first and second perceivable indicators are audible indicators, each having a distinct sound.
